(19) United States
(12) Patent Application Publication
(10) Pub. No.: US 2024/0037131 A1
(43) Pub. Date: Feb. 1, 2024

(54) SUBJECT-NODE-DRIVEN PREDICTION OF PRODUCT ATTRIBUTES ON WEB PAGES

(71) Applicant: Klarna Bank AB, Stockholm (SE)

(72) Inventors: Stefan Magureanu, Solna (SE); Riccardo Sven Risuleo, Stockholm (SE)

(21) Appl. No.: 17/875,300

(22) Filed: Jul. 27, 2022

(51) Int. Cl. G06F 16/35; H04L 67/02; G06F 16/95

(52) U.S. Cl. CPC G06F 16/355; H04L 67/02; G06F 16/95

(57) ABSTRACT

A set of nodes organized in a logical tree structure is obtained, where the set of nodes represent objects in a user interface. A first set of rankings is generated for the set of nodes, where the first set of rankings indicate likelihoods of nodes of the set of nodes corresponding to a first classification. A first node from the set of nodes that corresponds to the first classification is identified based at least in part on the first set of rankings. A second set of rankings that indicate likelihoods of descendent nodes of the first node corresponding to a second classification different from the first classification is determined. A second node from the descendent nodes that corresponds to the second classification is identified based at least in part on the second set of rankings. Data from an object in the user interface that corresponds to the second node is obtained.

### BACKGROUND

In the field of automating interaction with web pages, identifying web page elements with confidence can be difficult and time-consuming given the sheer number of objects in the average web page. Using a machine learning algorithm can be helpful in classifying web page elements, but training the machine learning classifier algorithm on every possible type of web page element is impractical, if not impossible. Even with a robust training set, due to the large number of possible web page elements, there is still a substantial risk of the machine learning classifier misidentifying a node of interest. For example, given a classifier with a 95% accuracy and a web page with 2,000 web elements, the machine learning algorithm might misidentify up to 100 web elements. Therefore, a need exists for techniques to efficiently and accurately classify web page elements.

### BRIEF DESCRIPTION OF THE DRAWINGS

Various techniques will be described with reference to the drawings, in which:

FIG. 1 illustrates an example of a system for more efficiently labeling nodes in accordance with an embodiment;

FIG. 2 illustrates an example of hierarchy of multiple interface objects in accordance with an embodiment;

FIG. 3 illustrates an example of a document object model tree with a root node in accordance with an embodiment;

FIG. 4 illustrates an example of labeling completion in accordance with an embodiment;

FIG. 5 illustrates an example of a scheme for determining nodes to choose in accordance with an embodiment;

FIG. 6 illustrates an example of training web-element predictors in accordance with an embodiment;

FIG. 7 is a flowchart that illustrates an example of a system for more efficiently labeling nodes in accordance with an embodiment;

FIG. 8 is a flowchart that illustrates an example of training a classifier in accordance with an embodiment; and

FIG. 9 illustrates a computing device that may be used in accordance with at least one embodiment/an environment in which various embodiments can be implemented.

### DETAILED DESCRIPTION

Techniques and systems described below relate to improving the accuracy of machine learning models and systems trained to identify and locate a specific object of interest, such as a particular web element, from among a plurality of objects. In one example, a document object model (DOM) tree of a web page is obtained, where the DOM tree comprises a set of nodes that represents HyperText Markup Language (HTML) elements of the web page. In the example, a machine learning model is utilized to produce a set of probabilities for the set of nodes by providing characteristics of the set of nodes as input to the machine learning model, where the set of probabilities include for each node of the set of nodes a first probability of the node being a subject node and a second probability of the node being a node of interest.

Further in this example, the subject node is identified from the set of nodes based at least in part on the set of probabilities, where the subject node is a lowest common ancestor (LCA), or least common ancestor, of a subset of the set of nodes and the subset of nodes includes the node of interest. Still further in the example, the node of interest is identified from the subset of nodes identifying using a subset of the set of probabilities that correspond to the subset of nodes. Finally in the example, data associated with an HTML element represented by the node of interest is extracted from the web page.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described and suggested in the present disclosure improve the field of computing, especially the field of machine learning and data augmentation, by selectively searching subtrees from a dataset to cause the system for labeling and identifying data to be more accurate using the same source of dataset in alternative ways. Additionally, techniques described and suggested in the present disclosure improve the accuracy of machine learning algorithms trained to recognize an object of interest from a multitude of other objects by reusing the data but grouping it alternatively (by subject nodes). Moreover, techniques described and suggested in the present disclosure are necessarily rooted in computer technology in order to overcome problems specifically arising with the ability of web automation software (e.g., plug-ins and browser extensions, automated software agents, etc.) to find the correct elements of a web page to interact with by using machine learning techniques to more accurately predict which web element is the element of interest.

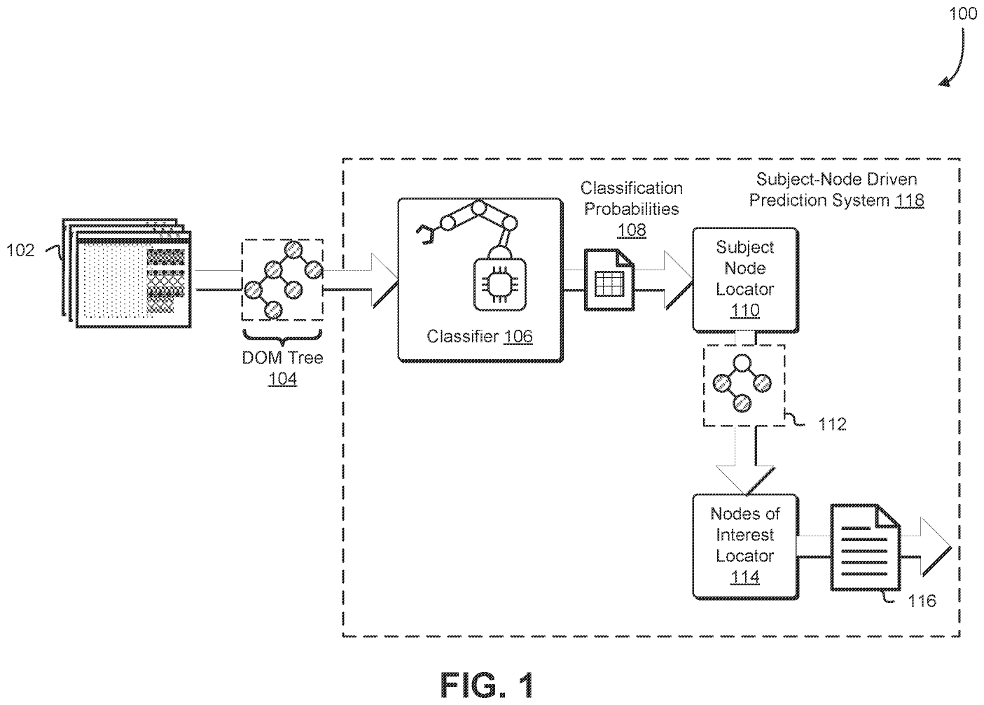

FIG. 1 illustrates an aspect of a system 100 in which an embodiment may be practiced. Accordingly, as illustrated in FIG. 1, the system 100 may include a subject-node-driven (SND) prediction system 118 that efficiently searches and accurately identifies web elements based on DOM tree input data 104 derived from the one or more web pages 102. Specifically, as illustrated in FIG. 1, the system 100 may further include a classifier 106 that obtains the DOM tree input data 104 derived from the one or more web pages 102 to produce a set of node classification probabilities 108. The nodes of the DOM tree may represent the HTML elements within the one or more web pages 102. The set of node classification probabilities 108 may be input to a subject node locator 110, which may identify a subset of the set of nodes of the DOM tree input data 104 comprising the subject node and its descendent nodes. This subset of nodes 112 may be input to the nodes of interest (NOI) locator 114, which in turn may identify an HTML element 116 represented by the node of interest. Once the HTML element 116 of interest is identified, data associated with the HTML element 116 may be extracted (e.g., if the HTML element 116 is an image, the image may be downloaded or displayed, if the HTML element 116 is a value or a label, the value or label may be obtained for display or further processing, etc.).

In some examples, an “element of interest” refers to a web page element that serves a purpose that an entity that implements an embodiment of the present disclosure is interested in. For example, an entity may be interested in locating which image on a particular consumer product (or service) page is the image of the particular consumer product (or service), and not images of other suggested/related products or images of buttons or other graphics. In such an implementation, the “product image” would be an element of interest. Likewise, the entity may also want to differentiate the text having the consumer product (or service) name in the web page from other text in the web page. In such an implementation, the “product name” would additionally or alternatively be an element of interest. Similarly, the entity may want to identify the numeric value of the consumer product (or service) cost—as differentiated from other numeric values found in the web page, such as those related to other products. In this case, the “product cost” would additionally or alternatively be an element of interest. In some examples, a “node of interest” refers to the node in the DOM tree of the web page that corresponds to the element of interest. The techniques of the present disclosure contemplates locating elements of interest that have semantic relationships to each other. That is, the types of elements interest described above are likely to have nodes that are located in relatively close proximity to each other in the DOM tree. Thus, the present disclosure describes the technique of finding a “subject node”—which is a node projected to be the lowest common ancestor of the semantically related nodes of interest. In this manner, once the subject node is located, the search for the nodes of interest may be restricted to just the descendent nodes of the subject node (the subset of nodes 112), and the remaining DOM tree nodes of the web page can be disregarded.

By restricting the search for the HTML element 116 to the subset of nodes 112, the efficiency (e.g., speed) and confidence of the SND prediction system 118 may be improved. Furthermore, by restricting the search for the HTML element 116 to the subset of nodes 112, the SND prediction system 118 may be implemented to more accurately identify web page elements than the classifier 106 alone since the nodes outside the subset of nodes 112 are unlikely to contain the HTML element 116. In this manner, the SND prediction system 118 may be able to recognize, classify, and give semantic relationships to nodes of a web page. The SND prediction system 118 may be provided characteristics of the set of nodes (e.g., names, values, dimensions, etc.) as input. In some embodiments, the characteristics may be tokenized into a vector prior to input to the classifier 106. The SND prediction system 118 may produce a set of probabilities for the set of nodes, including a first probability of a node being a subject node and a second probability of a node being a node of interest. The SND prediction system 118 may output an extraction of data associated with an HTML element 116 represented by a node of interest.

The one or more web pages 102, from which at least a portion of the DOM tree input data 104 is derived, may be a user interface to a computing resource service that a user may interact with using an input device, such as a mouse, keyboard, or touch screen. The one or more web pages 102 may be one or more HTML documents provided by a website that can be displayed to a user in a web browser. The website, of the one or more web pages 102, may consist of multiple web pages linked together in a coherent fashion. A website, of one or more web pages 102, may be hosted by a web server and accessible through a network, such as the Internet. The one or more web pages 102 may include various interface elements, such as text, images, links, tables, and the like. In an example, the one or more web pages 102 may operate as interfaces to a service of an online merchant (also referred to as an online merchant service) that allows a user to obtain, exchange, or trade goods and/or services with the online merchant and/or other users of the online merchant service.

Additionally, or alternatively, the one or more web pages 102 may allow a user to post messages and upload digital images and/or videos to servers of the entity hosting the one or more web pages 102. In another example, the one or more web pages 102 may operate as interfaces to a social networking service that enables a user to build social networks or social relationships with others who share similar interests, activities, backgrounds, or connections with others. Additionally, or alternatively, the one or more web pages 102 may operate as interfaces to a blogging or microblogging service that allows a user to transfer content, such as text, images, or video. Additionally, or alternatively, the one or more web pages 102 may be interfaces to a messaging service that allow a user to send text messages, voice messages, images, documents, user locations, live video, or other content to others.

In various embodiments, the system of the present disclosure may obtain (e.g., by

downloading) the one or more web pages 102 and extract various interface elements, such as HyperText Markup Language (HTML) elements, from the one or more web pages 102. The one or more web pages 102 may be at least one web page hosted on a service platform. In some examples, a “service platform” (or just “platform”) refers to software and/or hardware through which a computer service implements its services for its users. In embodiments, the various form elements of the one or more web pages 102 may be organized into a DOM tree hierarchy with nodes of the DOM tree representing web page elements. In some examples, the interface element may correspond to a node of an HTML form.

In some examples, a node represents information that is contained in a DOM or other data structure, such as a linked list or tree. Examples of information include but are not limited to a value, a clickable element, an event listener, a condition, an independent data structure, etc. In some examples, a form element refers to clickable elements which may be control objects that, when activated (such as by clicking or tapping), cause the one or more web pages 102 or any other suitable entity to elicit a response.

In some examples, an interface element is associated with one or more event listeners, which may be configured to elicit a response from the one or more web pages 102 or any other suitable entity. In some examples, an event listener may be classified by how the one or more web pages 102 respond. As an illustrative example, the one or more web pages 102 may include interfaces to an online library and the one or more web pages 102 may have nodes involving “Add to Queue” buttons, which may have event listeners that detect actual or simulated interactions (e.g., mouse clicks, mouse over, touch events, etc.) with the “Add to Queue” buttons. In the present disclosure, various elements may be classified into different categories. For example, certain elements of the one or more web pages 102 that have, when interacted with, the functionality of adding an item to a queue may be classified as “Add to Queue” elements, whereas elements that cause the interface to navigate to a web page that lists all of the items that have been added to the queue may be classified as “Go to Queue” or “Checkout” elements.

The DOM tree input data 104 may contain nodes corresponding to a

category/classification of interest, which are represented as nodes connected by lines in FIG. 1. A DOM tree input data 104 may be a hierarchical set of nodes organized in a logical tree structure representing at least one document (e.g., the one or more web pages 102), where each node represents a part of the document. The nodes of the DOM tree input data 104 may be initially unlabeled, at least until the probability of each node being the category/classification of interest is determined by the classifier 106. The trained classifier 106 may be trained to recognize the purposes of objects (such as represented by the DOM tree input data 104) in a dataset. In some examples, the “purpose” of an object refers to the function that the object serves in a web page. For example, a web page for a product for sale may include multiple images, but only a portion of the images may be images of the product. Those images may be classified with the purpose of being “product images.” Similarly, the web page may include multiple numerical values, but only one numerical value may represent the price of the product. Such numerical value may be classified as having the purpose of being the “product price.” Likewise, the web page may have multiple alphanumeric labels, but only one alphanumeric label may represent the name of the product. That alphanumeric label may be classified as being the “product name.”

The trained classifier 106 may output a set of node classification probabilities 108, wherein some of the set of node classification probabilities 108 may be inaccurate. For example, the set of node classification probabilities 108 may include a set of probabilities of the nodes corresponding to the category/classification of interest, where nodes that do not correspond to a category/classification of interest but were given a high probability of corresponding to the category/classification of interest (e.g., above the probability of an actual node corresponding to the category/classification of interest—also referred to as a “true positive” element — or a probability above a threshold probability) may be considered “mislabeled,” “incorrectly predicted,” or “negative examples.” In other words, there may be negative examples that may be incorrectly predicted to be a type of element that they are not.

In a logical tree structure, such as a DOM tree, a root node of the logical tree may be the node from which all other nodes descend; that is, an LCA node of all nodes in the document object model tree. A LCA node of two nodes, for example nodes v and w, may refer to the deepest (e.g., lower) node that has both nodes, v and w, as descendants. Deepest may refer to the node lower to the vertical bottom of the tree. A subject node may be a division (DIV) tag. A DIV tag in HTML defines a division of a section in an HTML document. Determination of a subject node can be done in multiple ways and in different categories, based on the DOM tree input data 104. A lowest common ancestor may be commonly used in data manipulation. There may be many methods to compute a lowest common ancestor, but in a simple computation a lowest common ancestor is determined by finding the first intersection of the paths (toward the root) of one node (v) and another node (w).

Each node of the DOM tree input data 104 may be tokenized as a feature vector

comprising attributes of the node. In some examples, a feature vector is one or more numeric values representing features that are descriptive of the object. Attributes/characteristics of the node transformable into values of a feature vector could be size information (e.g., height, width, etc.), the HTML of the node broken into tokens of multiple strings (e.g., [“input”, “class”, “goog”, “toolbar”, “combo”, “button”, “input,” “jfk”, “textinput”, “autocomplete”, “off”, “type”, “text”, “aria”, “autocomplete”, “both”, “tabindex”, “aria”, “label”, “zoom”]) such as by matching the regular expression /[A-Z]*[a-z]*/, or some other method of transforming a node into a feature vector.

The hierarchical set of nodes (e.g., DOM tree) may be tokenized to produce a set of tokens, an individual token of the set of tokens corresponding to a respective node of the hierarchical set of nodes. Depending upon the particular implementation, the nodes may be tokenized and/or transformed into feature vectors, which may be stored as a file or in a data store in lieu of storing the node. Otherwise, the node may be tokenized and transformed into a feature vector.

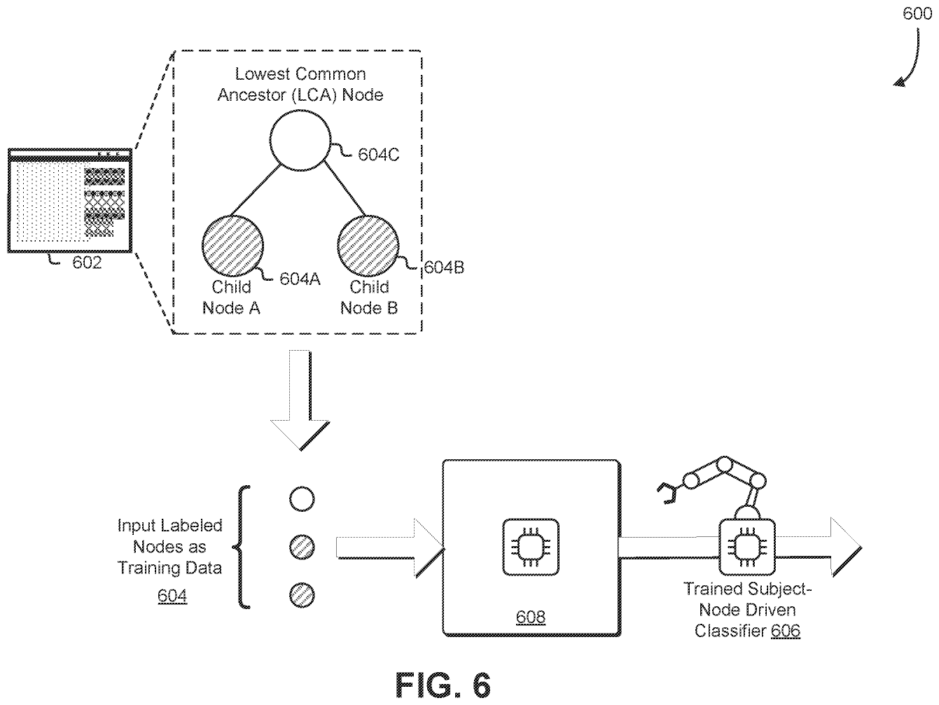

The SND prediction system 118 may include: the classifier 106, the subject node locator 110, and the NOI locator 114. The SND prediction system 118 may include a machine learning model that may be trained in accordance with FIG. 6. The machine learning model may be based on a supervised learning model, unsupervised learning model, or reinforcement learning model. Examples of machine learning models may include logistic regression, Apriori, naive Bayes classifier, perceptron algorithm, an attention neural network, a support-vector machine, Markov decision process, or some other machine learning model that receives a set of features and outputs confidence scores for one or more labels. The classifier 106 may be a machine learning model that is trained to classify nodes, such as the nodes from the DOM tree input data 104 extracted from the one or more web pages 102, to produce a set of node classification probabilities 108. The classifier 106 may be a machine learning model that has been trained (see FIG. 6) to recognize elements of interest in web pages as well as their functions, as described herein. The set of node classification probabilities 108 may be a set of nodes that have been labeled by the classifier 106 according to their purposes. For example, a set of node classification probabilities 108 may be: a price node associated with a video game console, an add to cart button, etc. The classification relates to a given node's purpose or content, or any other suitable manner to classify a node.

The set of node classification probabilities 108 is input to the subject node locator 110. The set of node classification probabilities 108 may also be a set of token classification probabilities, wherein said process would be applied to tokens. The subject node locator 110 may identify a subset of the set of node classification probabilities 108 which includes one or more nodes of interest. The subject node locator 110 may determine an LCA node of the subset of nodes. Probabilities of a set of nodes of interest may be generated. The node of interest probabilities include, for each node of the set of nodes: a first set of probabilities of the node corresponding to a first node type and a second set of probabilities of the node corresponding to a second node type. For example, set of node classification probabilities may include, for the nodes of the set of nodes, probabilities of the nodes being subject nodes of nodes of interest. The subject node locator 110 may determine, based at least in part on the probabilities of the nodes being subject nodes, which of the nodes is likely to be the subject node of the nodes of interest. In this context, the subject node may be an LCA node of a subset of the set of nodes, such as the of nodes of interest.

A first probability may be predicted, by the subject node locator 110, of a node being a subject node. The first probability may be used to identify a subject node probability higher than other subject node probabilities of the subject node probabilities. Further, the first probability may be used, at least in part, to identify a node as a subject node from the set of node classification probabilities 108. A second probability may be predicted of a node being a node of interest. The second probability may be used to identify a node of interest probability higher than other node of interest probabilities in the subset of probabilities. Further, the second probability may be used, at least in part, to identify a node as a subject node from the set of node classification probabilities 108. The first and second probabilities may be used, at least in part, to identify a node as a non-subject node from the set of node classification probabilities 108. There may be computed a difference between a first subject node probability and a second subject node probability wherein a first and a second subject node probability correspond to different nodes in a subset of nodes. The computed difference may be a value relative to a threshold difference (e.g., less than, less than or equal to, etc.). A threshold may be set manually or determined dynamically. The subject node locator 110 module may be a module responsible for identifying a subject nodes and its descendent nodes comprising the subset of nodes 112.

Additionally or alternatively, the node classification probabilities 108 further may be ranked according to classification. For example, a first set of rankings may indicate likelihood of nodes of the set of nodes corresponding to a first classification (e.g., subject node). A first node from the set of nodes may be determined to correspond to a first classification based, at least in part on the first set of rankings (e.g., a node having a higher ranking for the first classification than other nodes of the set of nodes may be determined to correspond to the first classification). A second set of rankings may be determined that indicate likelihoods of nodes of the set of nodes corresponding to a second classification different from the first classification. In embodiments the first set of rankings may be used to determine a first node of interest (e.g., a subject node) and the second set of rankings may be used to determine a second or other nodes of interest that descend from the first node of interest in the DOM tree. The second node may represent a digital image of a consumer product or service, a name of a consumer product or service, and/or a cost of a consumer product or service.

The subset of nodes 112 may be determined and output by the subject node locator 110. The subset of nodes 112 may be a subset of the set of nodes of the DOM tree input data 104. The subset of nodes 112 may be organized as a hierarchical tree structure with the root node of the subset of nodes 112 being the subject node described above. In some embodiments, a subset of the node classification probabilities 108 corresponding to the subset of nodes 112 may be used by the NOI locator 114 to identify one or more nodes of interest within the subset of nodes 112, such as a node corresponding to the HTML element 116.

Ideally, the node assigned the highest probability of being the category/classification of interest ideally would be the object of interest that falls under that category/classification. However, it is contemplated in this disclosure that a higher probability may be assigned to a node that is not the true positive node. That is, the initially trained machine learning algorithm may, on occasion, rank nodes that do not correspond to the particular classification of interest higher than the true positive element.

The subset of nodes 112 may be used to determine semantic relationships the nodes that are of interest (e.g., labeled by analysts initially in training data used to train the classifier 106) in a web page. In an example, a given web page is an online clothing retailer, and a web page for a blouse is shown. On the web page for the blouse, there may be numerous objects, including: a photo of the blouse, a price of the blouse, an add blouse to cart button, a rating out of five stars, and a name of the blouse (e.g. “Cold shoulder blue blouse”). A semantic relationship may exist between these elements, as they all relate to the particular blouse. In this case, for example, the least common ancestor (subject node) between all these elements may be, for example, an HTML DIV tag. Specifically, the HTML elements of the blouse (e.g., <IMG> tag for the photo, text for the price, button for “Add to Cart,” rating, and name text) may all occur in the HTML of the web page between <DIV> and </DIV> tags. Therefore, when searching for a particular element, the system of the present disclosure exploits this semantic relationship by restricting the search for the specific HTML elements to those elements that fall within a common HTML object. For example, if the system was searching for the price of the blouse, instead of going through every element of the DOM tree, the SND prediction system 118 can instead locate the subject node representing the <DIV> tag within the larger DOM tree, and then look for the price as a descendent of the <DIV> tag subject node. Therefore, the subject node may be a particular type of node of interest to be found initially (e.g., by the subject node locator 110) in order to more easily find other nodes of interest with semantic relationships, such as, in this example, photo, price, and name.

As noted above, the subset of nodes 112 may be input to the NOI locator 114. The NOI locator 114 may identify the node(s) of interest within the subset of nodes 112. Further, the NOI locator 114 may use the subset of the set of probabilities that correspond to the subset of nodes 112 to identify the node of interest from the subset of nodes 112. The node or nodes of interest may be nodes that correspond to particular classifications (e.g., product image, product name, etc.) in the web page that hold data that is of interest to a user or usable by web scrapers or other applications. For example, nodes of interest on an online retailer website could include: a price of an object, a name of an object, and an image of an object. The NOI locator 114 may use the subset of nodes 112 (which are classified and organized by subject node) to more easily search for a node of interest and output data associated with an HTML element 116 represented by the node of interest. The NOI locator 114, additionally or alternatively, may obtain data from an object in the user interface that corresponds to the identified node of interest (e.g., the NOI locator 114 may output data associated with the HTML element 116). For example, the SND prediction system 118 may use the predicted lowest ancestor (e.g., subject node) to reduce the number of nodes considered as candidates for nodes of interest and therefore greatly reduce the chance of encountering outliers that could fool the classifier when looking for the most likely candidate elements.

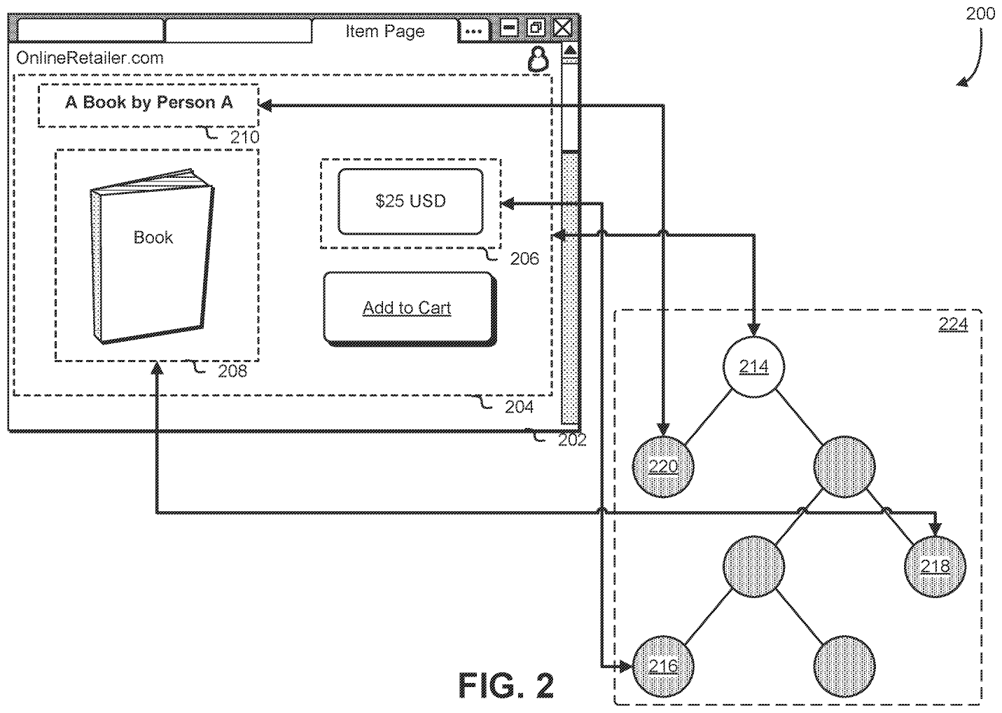

FIG. 2 illustrates an aspect of an example 200 of an interface 202 that an embodiment of the present disclosure can analyze for subject node prediction and classification. The interface 202 may be an interface similar to a web page of the set of web pages 102 of FIG. 1, which may be able to be represented in a DOM tree structure and includes elements that might elicit a response from the interface, network, data store, etc. As illustrated in FIG. 2, the interface can include various interface elements, such as text, images, links, tables, and the like, including a name object 210, an image object 208, a logical grouping object 204, and a price object 206. Some of such graphical elements may be engaged with by a user, such as by using a touch screen on the client device, by using voice commands audible to a microphone of the client device, and/or by using an input device (e.g., keyboard, mouse, etc.). Each of the objects 204-10 may be represented in a subtree 224 of a DOM tree of the interface 202 by their corresponding nodes 214-20. Specifically, FIG. 2 depicts the interface as a web page for an online retailer. A web page is one example of an interface contemplated by the present disclosure. A graphical user interface of a software application is another example of an interface contemplated by the present disclosure.

The logical grouping object 204 may be an HTML element that has, nested within its opening and closing tags, one or more other objects. In the example 200, the logical grouping object 204 includes within it the price object 206, the image object 208, and the name object 210 (among others). The HTML structure of the logical grouping object 204 and the other objects within it may look something like:

```
<div id=“d1”>
  <p>A book by Person A</p>
  <table border=“0”>
  <tr>
    <td><img src=“book.jpg”></td>
    <td>$25 USD
    <br>
    <input type=“submit” src=“cart.jpg” value=“Add to
    Cart”></td>
  </tr>
  </table>
</div>
```

As can be seen, the <div id=“d1”> . . . </div> tags are the nearest tags that include all of the HTML elements of interest in this particular implementation: the product name (“A book by Person A”), the product image (“book.jpg”) and price (“$25 USD”), making the node that corresponds to the <div> tags in the DOM tree of the interface the subject node of the elements of interest (e.g., the subject node 214).

The determination of the subject node 214 is described in relation to FIG. 1 above. The price of the book (e.g., price object 206) corresponds to the node 216, shown as a descendant of the subject node 214. The image object 208 of the book corresponds to the node 218, also shown as a descendent of the subject node 214. The title of the book (name object 210) corresponds to the node 220, likewise shown as a descendant of the subject node 214. In this manner, all of the nodes of interest may be found within the subtree 224 of the DOM tree, where the nodes 216-20 of the subtree 224 all descend from the subject node 214.

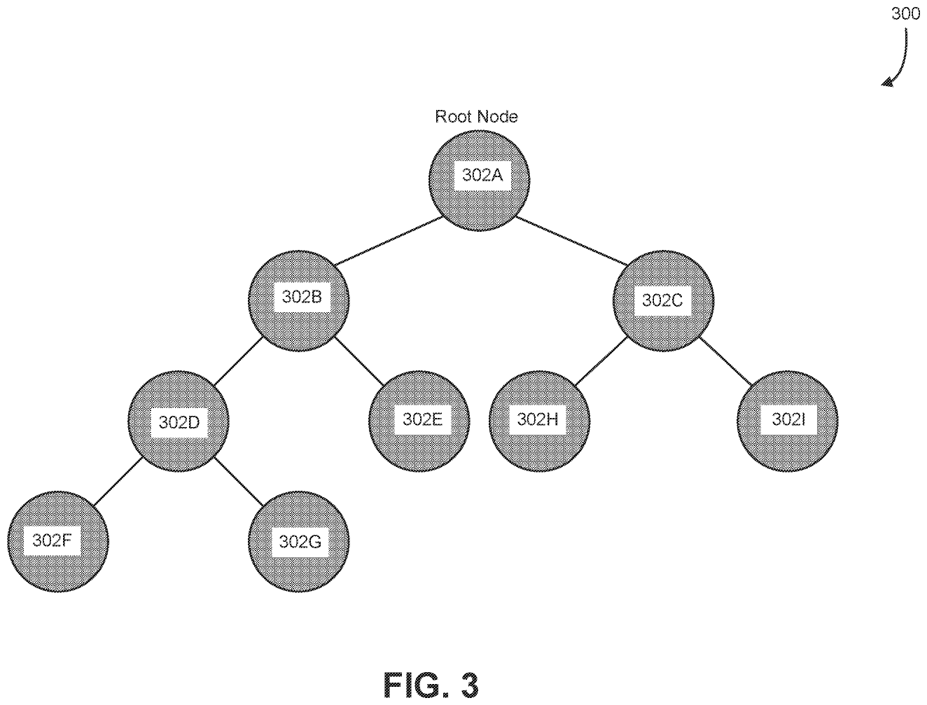

FIG. 3 is an illustrative example of a DOM tree 300 of an interface in which an embodiment may be practiced. FIG. 3 depicts the starting condition of the operation done within the SND prediction system 118, as described in FIG. 1 above. The DOM tree 300 may be similar to the DOM tree input data 104, and represents the input of the DOM tree into the classifier 106. Specifically, FIG. 3 depicts the DOM tree 300 with a root node 302A and a set of DOM nodes 302B-I. The shading is intended to illustrate that the set of DOM nodes 302B-I have not yet been evaluated (e.g., by the classifier 106 of FIG. 1 above). Consequently, the set of DOM nodes 302B-I may not yet be labeled.

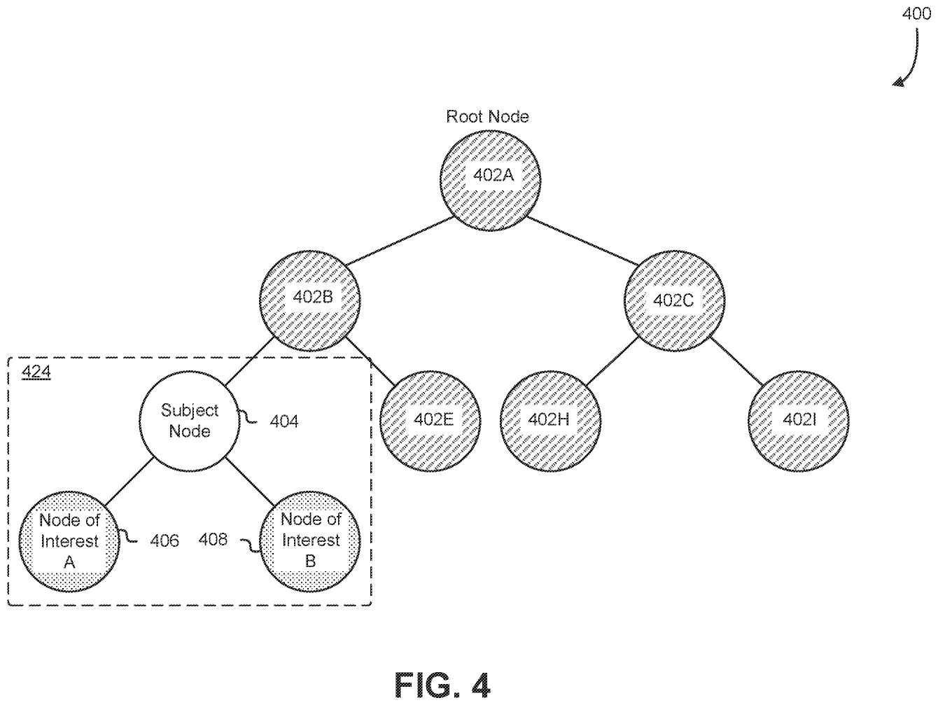

FIG. 4 is an illustrative example of a DOM tree 400 of an interface in which an embodiment may be practiced. Specifically, FIG. 4 depicts the DOM tree 400 after the SND prediction system 118 has identified the subject node and its descendants (subtree 424), as described in FIG. 1 above, wherein all the nodes are classified and the subject node is identified. This represents the nodes of interest, as described in FIG. 1 above. The striped line shading is intended to illustrate that the set of DOM nodes 402A, B, E, H, C, and I have been evaluated (e.g., by the classifier 106 of FIG. 1 above). Consequently, the set of DOM nodes 402A, B, E, H, C, and I may be labeled. The white shading is intended to illustrate that DOM node 404 is a node of interest—specifically, the subject node, and is labeled as such (e.g., subject node). The dotted shading is intended to illustrate that the set of DOM nodes 406 and 408 are nodes of interest. The dashed box is intended to illustrate that in searching for the nodes of interest, after classification, the SND prediction system 118 identifies the subtree 424 in which nodes of interest are likely to be found and the NOI locator 114 of FIG. 1 constrains its search for nodes of interest to the nodes of the subtree 424.

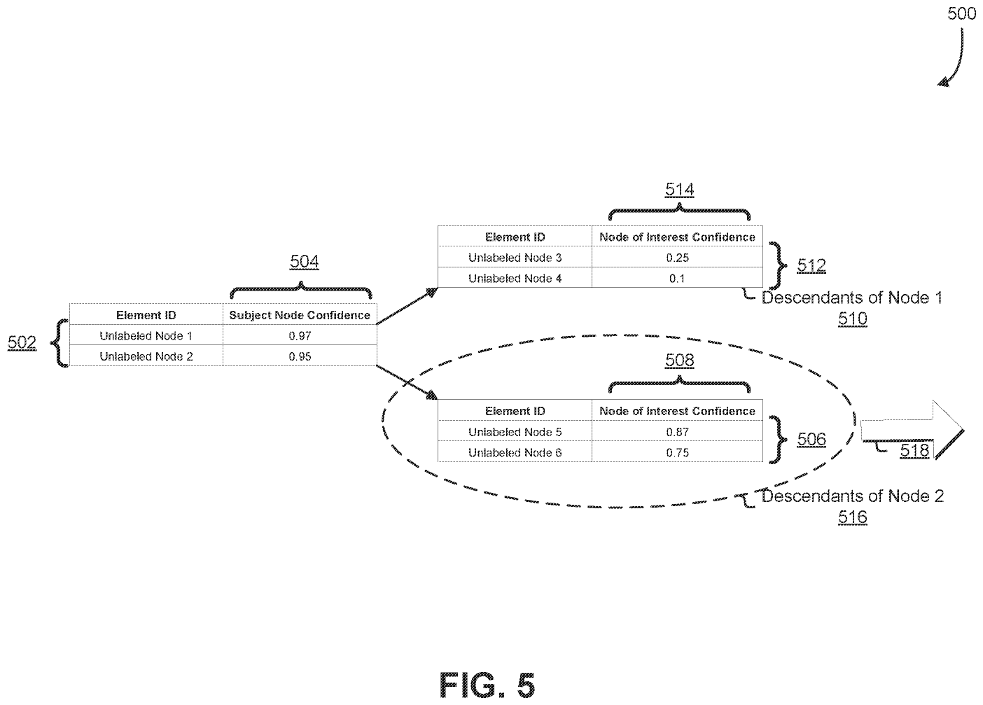

FIG. 5 illustrates another aspect of an embodiment 500 that may be practiced. In particular, FIG. 5 illustrates alternate strategies for choosing which subtrees are to be used in a search of a dataset for a SND prediction system. Specifically, FIG. 5 illustrates a technique for dealing with a situation where the node with the highest probability of being the subject node of a DOM tree is not the actual subject node with nodes of interest as its descendants. As illustrated in FIG. 5, the embodiment 500 may include a set of subject node confidence scores 504, such as might be produced by the classifier 106 of FIG. 1, in which nodes are given a score or probability of being the subject node of a DOM tree.

The subject node confidence scores 504 may be at least a portion of output from a classifier, such as the classifier 106 of FIG. 1. The subject node confidence scores 504 may indicate a likelihood that a given element corresponds to a subject node/subject node of interest. In FIG. 5, the subject node confidence scores 504 may be ranked/ordered based on an assigned score. The elements and scores are illustrated in FIG. 5 in order of decreasing probability, but it is contemplated that, depending on implementation, the system of the present disclosure may not necessarily order the scores in this manner.

In the illustrated examples of FIG. 5, the elements being ranked include descendants 510 of node 1 and descendants 516 of node 2. Unlabeled node 1 has unlabeled nodes 3 and 4 512 as descendants. Unlabeled node 2 has unlabeled element nodes 5 and 6 506 as descendants.

The candidate subject nodes 1 and 2 502 and the unlabeled nodes 3 and 6 506 and 512 may be elements from a single web page. The candidate subject nodes 1 and 2 502 and the unlabeled nodes 3 and 6 506 and 512 may have an assigned score by a machine learning model, such as the classifier 106 of FIG. 1. In some examples, the assigned score by the initially trained machine learning model may be a probability between 0 and 1, wherein 0 is the lowest confidence and 1 is the highest confidence. However, it is also contemplated that, in some embodiments, this case may be the opposite.

FIG. 5 illustrates a situation where unlabeled node 1 of the candidate subject nodes 502 has been assigned the highest probability of being the subject node in a web page. However, the node of interest confidence scores 514 for the unlabeled nodes 3 and 4 512 are quite low (e.g., below a threshold confidence value), indicating that the unlabeled node 1 is likely not the subject node. On the other hand, the unlabeled nodes 5 and 6 506, while descending from unlabeled subject node 2 of the candidate subject nodes 502 (which has a slightly lower subject node confidence score than unlabeled node 1's subject node confidence), have node of interest confidence scores 508 that are notably higher than the node of interest confidence scores 514. This indicates, therefore, that unlabeled node 1 is most likely the subject node. Consequently, techniques of the present disclosure include taking into account the node of interest confidence scores in determining which of the candidate subject nodes 1 and 2 502 is the subject node.

Thus, in some embodiments, identification of a subject node is based on the subject node confidence scores, without taking node of interest confidence scores into consideration. Alternatively, in some embodiments, determination of a subject node includes searching through the candidate subject nodes' subtrees and taking the node of interest confidences scores into consideration. It is further contemplated that, in some embodiments, node of interest confidence scores are taken into consideration only when the top candidate subject nodes' subject node confidence scores are close (e.g., below a threshold difference in probabilities).

In one example, if the difference between the first and second top candidate subject node probabilities is less than a 0.1 threshold difference, the node of interest confidence scores are taken into account. In the example shown in FIG. 4, the difference between the subject node confidence scores 504 of the candidate subject nodes 502 is 0.02 (0.97−0.95), which is below the aforementioned threshold difference. In this example, then, the node of interest confidence scores 508 and 514 may be factored into the determination. It is contemplated that various methods of factoring the node of interest confidence scores may be used, but one example is to take an average of the top N node of interest confidence scores of the descendants of the candidate subject nodes and multiplying the result against the subject node confidence scores of the respective candidate subject nodes. In this example, for the embodiment 500, if N=2 the top two node of interest confidence scores 514 may be averaged and multiplied against the subject node confidence score of unlabeled node 1 to produce an overall subject node confidence score for unlabeled node 1:

$$\frac{0.25 + 0.1}{2} \times 0.97 ≅ 0.17$$

Likewise, in this example, the top two node of interest confidence scores 508 may be averaged and multiplied against the subject node confidence score of unlabeled node 2 to produce an overall subject node confidence score for unlabeled node 2:

$$\frac{0.87 + 0.75}{2} \times 0.95 ≅ 0.77$$

Thus, in this embodiment, unlabeled node 2, having the highest overall subject node confidence score, is determined to be the subject node for the web page.

FIG. 6 illustrates an aspect of a system 600 in which an embodiment may be practiced. As illustrated in FIG. 6, the system 600 may include a machine learning model 608 that is trained 20 on an initial training dataset 604, which is derived from one or more web pages 602. The training produces a classifier 606 for an SND prediction system, such as the classifier 106 of the SND prediction system 118 of FIG. 1.

The one or more web pages 602 may be the same or a different set of web pages as the one or more web pages 102 of FIG. 1. As with the one or more web pages 102, the one or more web pages 102 may be user interfaces to a computing resource service that a user may interact with using an input device, such as a mouse, keyboard, or touch screen. Likewise, the one or more web pages 102 may include various interface elements, such as text, images, links, tables, and the like.

In one example, the one or more web pages 602 is a web page for a product or service, and the training dataset 604 may be derived from a set of nodes, with at least one node of interest labeled as corresponding to a particular category (e.g., by a human operator). In some implementations, an individual web page in the training dataset 604 has just a solitary node labeled as corresponding to the particular category. In some examples, the label is a name, or an alphanumerical code, assigned to a node, where the label indicates a category/classification of the type of node. Other nodes of the web page may be unlabeled or may be assigned different categories/classifications. In the example 600, the training dataset 604 may be used to train the machine learning model 608, thereby resulting in the trained SND prediction system 118. In this manner, the machine learning model 608 may be trained to recognize elements of interest in web pages as well as their purposes and, potentially, their semantic relationships.

Nodes from each page of the one or more web pages 602 likewise have at least one node labeled by a human operator as belonging to the particular category/classification. It is also contemplated that the various web pages of the one or more web pages 602 may be user interfaces to the same or different computing resource service (e.g., different merchants). In addition to being labeled or unlabeled, each node of the training dataset 604 may be associated with a feature vector comprising attributes of the node. In some examples, a feature vector is one or more numeric values representing features that are descriptive of the object. Attributes of the node transformable into values of a feature vector could be size information (e.g., height, width, etc.), the HTML, of the node broken into tokens of multiple strings (e.g., [“input”, “class”, “goog”, “toolbar”, “combo”, “button”, “input,” “jfk”, “textinput”, “autocomplete”, “off”, “type”, “text”, “aria”, “autocomplete”, “both”, “tabindex”, “aria”, “label”, “zoom”]) such as by matching the regular expression /[A-Z]*[a-z]*/, or some other method of transforming a node into a feature vector.

The training dataset 604 may be a set of nodes 624 representing elements from the one or more web pages 602. The training dataset 604 may include feature vectors and labels corresponding to nodes that were randomly selected, pseudo-randomly selected, or selected according to some other stochastic or other selection method from the one or more web pages 602. Individual nodes of the training dataset 604 may be assigned labels by a human operator. In the illustrative example shown in FIG. 6, the training dataset 604 is composed of a child node A 604A, a child node B 604B, and an LCA node 604C. Further detail regarding LCA nodes is described above in relation to FIG. 1.

The machine learning model 608 may be trained in this manner to predict the parent node (also referred to as the subject node) that is the lowest common ancestor of nodes of interest (that is, nodes corresponding to labels of interest). Thus, the machine learning model 608 learns to predict subtrees that are most likely to contain nodes corresponding to the labels of interest. In the training dataset at least two nodes of interest may be identified, along with their LCA node. Further, a first set of rankings may be utilized to determine a second set of rankings based on the two nodes of interest to classify nodes. For example, in one embodiment the first set of rankings may be a dataset that includes each of the nodes of the DOM tree, a probability of being a subject node, probability of being a first node of interest, probability of being a second node of interest, and so on for however many nodes of interest are being predicted. Once the subject node is determined (as described in relation to FIG. 5 and throughout the present disclosure), the second set of rankings may include only the probabilities for the nodes that are descendants of the subject node (and the rest may be pruned). In another embodiment, the first set of rankings may be a dataset that includes probabilities of each of the nodes of the DOM tree being a subject node. Once the subject node is identified based on the first set of rankings, a second set of rankings may be generated (or filtered from a larger set of rankings for all nodes of the DOM tree) that includes only the node of interest probabilities for the nodes that are descendants of the subject node. In this manner, the LCA node of at least two nodes of interest may be labeled as a subject node and the model may be trained to identify subject nodes using this training data.

In some embodiments, a second machine learning model trained to classify nodes of interest generates the second set of rankings for the descendent nodes. LCA nodes may be used as training data to train the first machine learning model to compute rankings indicating the likelihood of nodes corresponding to a first classification (e.g., subject node). The same or second machine learning model (depending on the embodiment implemented) may be trained, using the at least two nodes of interest, to compute rankings indicating likelihoods of the nodes corresponding to at least a second classification (e.g., product image, product name, price, etc.).

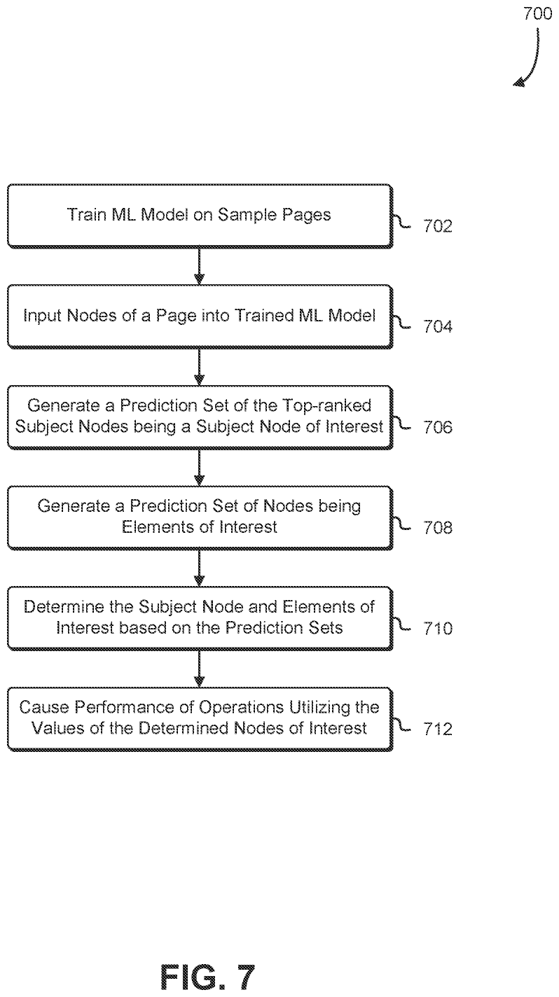

FIG. 7 is a flowchart illustrating an example of a process 700 for training a machine

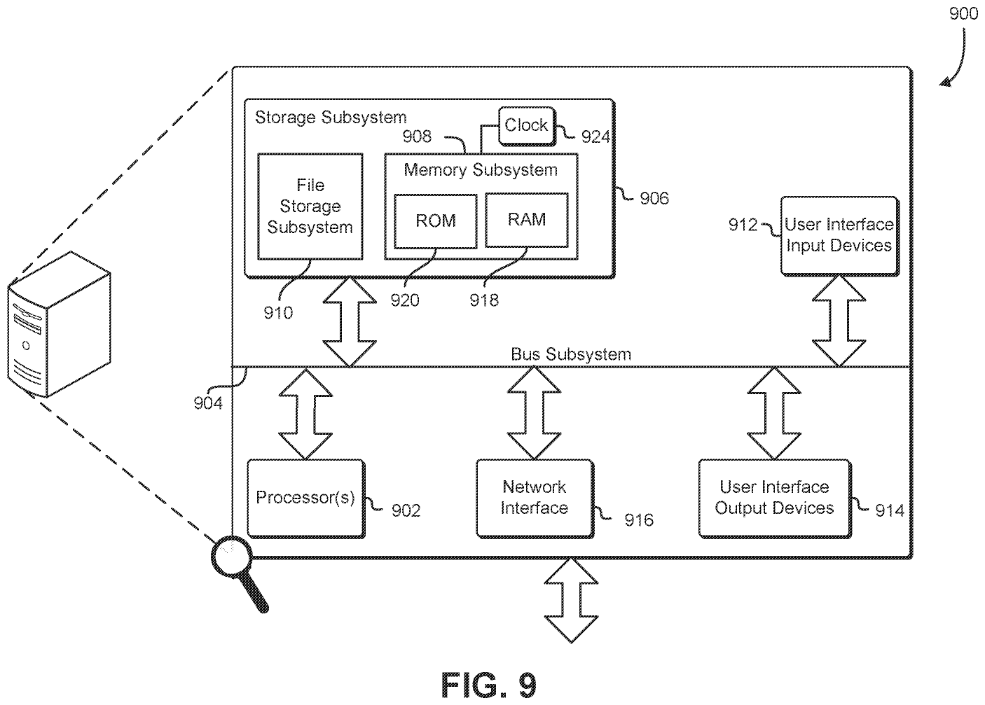

learning model in accordance with various embodiments. Some or all of the process 700 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 700 may be performed by any suitable system, such as the computing device 900 of FIG. 9. The process 700 includes a series of operations wherein a machine learning model is trained, a prediction of the top-ranked subject nodes being a subject node of interest is generated, top-ranked subject nodes are inputted into a machine learning model, a prediction set of nodes as elements of interest are generated, the nodes are labeled, and the training of the machine learning model continues.

In 702, the system performing the process 700 trains a machine learning model by at least obtaining a selection of nodes (e.g., at random) of at least one web page, and then training the machine learning model on this selection of nodes. It is contemplated that such web pages may be downloaded from one or more providers, whereupon each of the web pages may be transformed into a DOM tree with elements of the web page represented by the nodes of the DOM tree. These nodes may be stored in a data store or a file, and at 702 the nodes may be retrieved from the data store or file in order to train the machine learning model. Depending upon the particular implementation, the nodes may be tokenized and/or transformed into feature vectors, which may be stored as a file or in a data store in lieu of storing the node. Otherwise, the node may be tokenized and transformed into the feature vector in 702 for input as training data for the machine learning model.

After the machine learning model has been trained in 702, in 704, the system performing the process 700 is ready to begin classifying nodes of web pages. For example, in 704, for a given web page, the system derives a set of inputs from the web page; for example, the system may obtain the web page, determine the DOM representation of the web page, and derive a set of inputs based on characteristics of the nodes of the DOM representation. Characteristics of the node may be tokenized into a value suitable for input into the trained machine learning model; for example, the node characteristics may be tokenized into a string, binary numeral, or multi-dimensional vector usable as input by the machine learning model.

In 706, the system performing the process 700 generates a subject node prediction set from the output of the trained machine learning model as the inputs for each node (according to 704) are input into the trained machine learning model. The subject node prediction set may indicate nodes having the highest probabilities of being a subject node. Thus, the prediction set may be a set of probabilities, where each of the probabilities indicates a likelihood of a corresponding top-ranked node being a subject node. The nodes may be ranked in order of likelihood (e.g., based on probabilities that a given node is a subject node, as described in regard to FIG. 1 above). Examples of the generation of a prediction set may be seen in FIGS. 1, 3, and 4.

In 708, the system performing the process 700 generates an NOI prediction set from the output of the trained machine learning model as the inputs for each node (according to 704) are input into the trained machine learning model according to 704. The NOI prediction set may indicate the probabilities of the nodes being each type of element of interest. It is contemplated, however, that the subject node prediction set and the NOI prediction set are the same set, with probabilities of the nodes being each type of element of interest in addition to probabilities of the nodes being a subject node (e.g., where the subject node is a particular type of element of interest).

In 710 the subject node and the elements of interest are identified based on the subject node prediction set and the NOA prediction set. In some embodiments, the NOI prediction set excludes, or is pruned to exclude, predictions (e.g., probabilities, rankings, scores, etc.) for nodes that are not descendants of the top-ranked subject node. In this manner, processing is made more efficient as elements of interest are unlikely to not be descendants of the subject node. In various embodiments, the NOI prediction set may be first used in combination with the subject node prediction set to determine which node is the subject node, such as in the manner described in relation to FIG. 5.

Now that the elements of interest are identified in the web page, in 712, various operations may be performed using the values of those elements of interest in the web page. For example, if the nodes of interest are a product image, product name, and product price, the image, name, and price may be extracted and displayed in a separate browser window, stored in a database (e.g., a database accumulating a list of products, a database storing favorited items of a user), used to calculate a queue total, etc. Note that one or more of the operations performed in 702-12 may be performed in various orders and combinations, including in parallel. For example, determining the subject node may be performed between 706 and 708, prior to the generating the NOI prediction set.

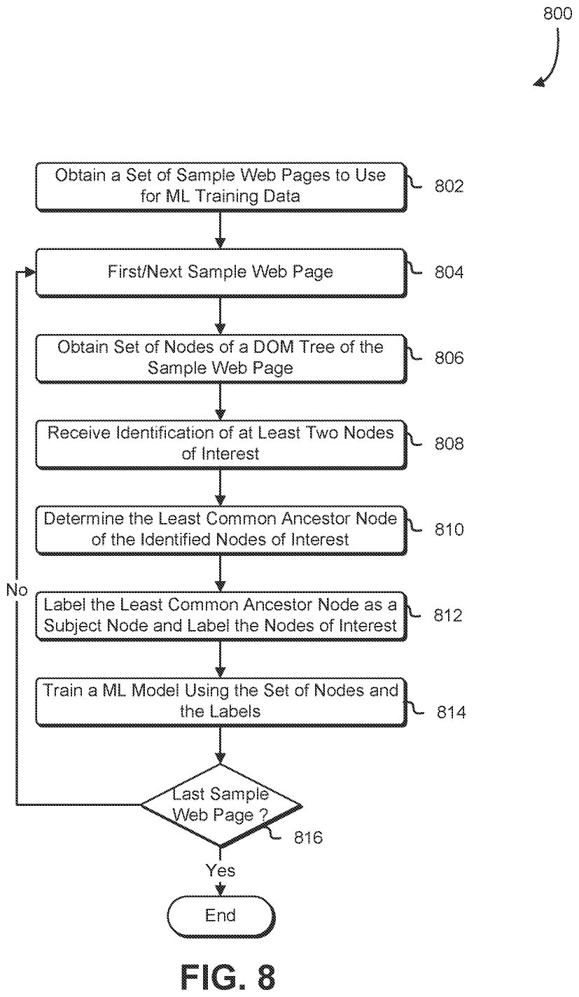

FIG. 8 is a flowchart illustrating an example of a process 800 for training a machine learning model in accordance with various embodiments. Some or all of the process 800 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 800 may be performed by any suitable system, such as the computing device 900 of FIG. 9. The process 800 includes a series of operations wherein a set of nodes is received, human interaction is simulated, metadata about semantic relationship and behavior is stored, and the process repeats until the last set of nodes is parsed through.

In 802, the system performing the process 800 obtains a set of sample web pages for use in training a machine learning algorithm. The sample web pages may be interfaces to an online merchant website. Each of the sample web pages may have nodes of interest. In 804, the system performing the process 800 begins processing the web pages by obtaining a first (or, if returning from 816) a next sample web page. In 806, the system obtains a set of nodes of a DOM tree representing the web page, where each of the set of nodes represents an element in the web page.

In 808, elements of interest are identified, such as by a human operator, to the system performing the process 800. Then, in 810, the system determines which node in the set of nodes of the DOM tree is the LCA of the nodes corresponding to the identified elements. In 812, the system labels the nodes of interest (as whatever classification they were identified as in 808) and labels the LCA node as a subject node.

In 814, the system performing the process 800 provides the labeled nodes (including the subject node) as training input to a machine learning model, so as to train the machine learning model to identify subject nodes and nodes of interest. In some embodiments, other unlabeled nodes of the set of nodes are also provided as training data to the machine learning model. Note that providing a node as training input includes tokenizing the node by transforming characteristic values of the node into a vector or other value suitable as training input for the machine learning model.

In 816, the system performing the process 800 determines whether each of the set of sample web pages has been processed. If the last sample web page has not yet been processed, the system returns to 804 to process the next web page. If the last sample web page has been processed, the machine learning model is trained and the system can end the process. Note that one or more of the operations performed in 802-16 may be performed in various orders and combinations, including in parallel.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 9 is an illustrative, simplified block diagram of a computing device 900 that can be used to practice at least one embodiment of the present disclosure. In various embodiments, the computing device 900 includes any appropriate device operable to send and/or receive requests, messages, or information over an appropriate network and convey information back to a user of the device. The computing device 900 may be used to implement any of the systems illustrated and described above. For example, the computing device 900 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 900 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 9, the computing device 900 may include one or more processors 902 that, in embodiments, communicate with and are operatively coupled to a number of peripheral subsystems via a bus subsystem. In some embodiments, these peripheral subsystems include a storage subsystem 906, comprising a memory subsystem 908 and a file/disk storage subsystem 910, one or more user interface input devices 912, one or more user interface output devices 914, and a network interface subsystem 916. Such storage subsystem 906 may be used for temporary or long-term storage of information.

In some embodiments, the bus subsystem 904 may provide a mechanism for enabling the various components and subsystems of computing device 900 to communicate with each other as intended. Although the bus subsystem 904 is shown schematically as a single bus, alternative embodiments of the bus subsystem utilize multiple buses. The network interface subsystem 916 may provide an interface to other computing devices and networks. The network interface subsystem 916 may serve as an interface for receiving data from and transmitting data to other systems from the computing device 900. In some embodiments, the bus subsystem 904 is utilized for communicating data such as details, search terms, and so on. In an embodiment, the network interface subsystem 916 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 916 is enabled by wired and/or wireless connections and combinations thereof

In some embodiments, the user interface input devices 912 includes one or more user

input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 900. In some embodiments, the one or more user interface output devices 914 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 900. The one or more user interface output devices 914 can be used, for example, to present user interfaces to facilitate user interaction with applications performing processes described and variations therein, when such interaction may be appropriate.

In some embodiments, the storage subsystem 906 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 906. These application modules or instructions can be executed by the one or more processors 902. In various embodiments, the storage subsystem 906 additionally provides a repository for storing data used in accordance with the present disclosure. In some embodiments, the storage subsystem 906 comprises a memory subsystem 908 and a file/disk storage sub system 910.

In embodiments, the memory subsystem 908 includes a number of memories, such as a main random-access memory (RAM) 918 for storage of instructions and data during program execution and/or a read only memory (ROM) 920, in which fixed instructions can be stored. In some embodiments, the file/disk storage subsystem 910 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 900 includes at least one local clock 924. The at least one local clock 924, in some embodiments, is a counter that represents the number of ticks that have transpired from a particular starting date and, in some embodiments, is located integrally within the computing device 900. In various embodiments, the at least one local clock 924 is used to synchronize data transfers in the processors for the computing device 900 and the subsystems included therein at specific clock pulses and can be used to coordinate synchronous operations between the computing device 900 and other systems in a data center. In another embodiment, the local clock is a programmable interval timer.

The computing device 900 could be of any of a variety of types, including a portable computer device, tablet computer, a workstation, or any other device described below. Additionally, the computing device 900 can include another device that, in some embodiments, can be connected to the computing device 900 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 900 for processing. Due to the ever-changing nature of computers and networks, the description of the computing device 900 depicted in FIG. 9 is intended only as a specific example for purposes of illustrating the preferred embodiment of the device. Many other configurations having more or fewer components than the system depicted in FIG. 9 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 900 may include any appropriate hardware, software and firmware for integrating with a data store as needed to execute aspects of one or more applications for the computing device 900 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 900 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 900 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 900 may provide the content in one or more forms including, but not limited to, forms that are perceptible to the user audibly, visually, and/or through other senses. The handling of requests and responses, as well as the delivery of content, in an embodiment, is handled by the computing device 900 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 900 typically will include an operating system

that provides executable program instructions for the general administration and operation of the computing device 900 and includes a computer-readable storage medium (e.g., a hard disk, random access memory (RAM), read only memory (ROM), etc.) storing instructions that if executed (e.g., as a result of being executed) by a processor of the computing device 900 cause or otherwise allow the computing device 900 to perform its intended functions (e.g., the functions are performed as a result of one or more processors of the computing device 900 executing instructions stored on a computer-readable storage medium).

In an embodiment, the computing device 900 operates as a web server that runs one or more of a variety of server or mid-tier applications, including Hypertext Transfer Protocol (HTTP) servers, FTP servers, Common Gateway Interface (CGI) servers, data servers, Java servers,

Apache servers, and business application servers. In an embodiment, computing device 900 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, or TCL, as well as combinations thereof. In an embodiment, the computing device 900 is capable of storing, retrieving, and accessing structured or unstructured data. In an embodiment, computing device 900 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of

describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
obtaining a document object model (DOM) tree of a web page, the DOM tree comprising a set of nodes that represents HyperText Markup Language (HTML) elements of the web page;
utilizing, by providing characteristics of the set of nodes as input to a machine learning model, the machine learning model to produce a set of probabilities for the set of nodes, the set of probabilities including, for each node of the set of nodes:
a first probability of the node being a subject node; and
a second probability of the node being a node of interest;
identifying, based at least in part on the set of probabilities, the subject node from the set of nodes, the subject node being a lowest common ancestor (LCA) of a subset of the set of nodes, the subset of nodes including the node of interest;
identifying, using a subset of the set of probabilities that correspond to the subset of nodes, the node of interest from the subset of nodes; and
extracting, from the web page, data associated with an HTML element represented by the node of interest.

2. The computer-implemented method of claim 1, further comprising:
obtaining an initial DOM tree of an initial web page, the initial DOM tree comprising an initial set of nodes that represents initial HTML elements of the initial web page;
identifying a subset of the initial set of nodes that includes one or more nodes of interest;
determining an LCA node of the subset of nodes; and
training, using at least the LCA node, the machine learning model to classify subject nodes in web pages.

3. The computer-implemented method of claim 1, wherein identifying the subject node includes identifying the subject node based at least in part on the first probability of the subject node.

4. The computer-implemented method of claim 3, wherein identifying the subject node is further based at least in part on the second probability of the node of interest.

5. A system, comprising:
one or more processors; and
memory including computer-executable instructions that, if executed by the one or more processors, cause the system to:
obtain a set of nodes organized in a logical tree structure, the set of nodes representing objects in a user interface;
generate a first set of rankings for the set of nodes, the first set of rankings indicating likelihoods of nodes of the set of nodes corresponding to a first classification;
identify, based at least in part on the first set of rankings, a first node from the set of nodes that corresponds to the first classification;
determine a second set of rankings that indicate likelihoods of descendent nodes of the first node corresponding to a second classification different from the first classification;
identify, based at least in part on the second set of rankings, a second node from the descendent nodes that corresponds to the second classification; and
obtain data from an object in the user interface that corresponds to the second node.

6. The system of claim 5, wherein:
the user interface is a web page; and
the logical tree structure is a document object model tree of the web page.

7. The system of claim 5, wherein the second set of rankings is a subset of the first set of rankings that corresponds to the descendent nodes.

8. The system of claim 5, wherein the second node represents one of:
a digital image of a consumer product or service,
a name of the consumer product or service, or
a cost of the consumer product or service.

9. The system of claim 5, wherein:
the computer-executable instructions further include instructions that further cause the system to:
obtain a training set of nodes that represents objects in an example user interface; and
identify at least two of nodes of interest within the training set; and
the computer-executable instructions cause the system to generate the first set of rankings or determine the second set of rankings include instructions that cause the system to generate the first set of rankings or determine the second set of rankings using a machine learning model trained, based at least in part on the at least two nodes of interest, to classify nodes.

10. The system of claim 9, wherein:
the machine learning model is a first machine learning model; and
the computer-executable instructions that cause the system to determine the second set of rankings further include instructions that further cause the system to generate, using a second machine learning model trained to classify nodes of interest, the second set of rankings for the descendent nodes.

11. The system of claim 9, wherein the computer-executable instructions further include instructions that further cause the system to:
determine a lowest common ancestor (LCA) node of the at least two nodes of interest; and
train, using at least the LCA node as training data, the machine learning model to compute rankings indicating the likelihood of the nodes corresponding to the first classification.

12. The system of claim 9, wherein the computer-executable instructions further include instructions that further cause the system to train, using the at least two nodes of interest, to compute rankings indicating likelihoods of the nodes corresponding to the second classification.

13. A non-transitory computer-readable storage medium having stored thereon executable instructions that, if executed by one or more processors of a computer system, cause the computer system to at least:
obtain a hierarchical set of nodes representing an interface to an Internet site;
tokenize the hierarchical set of nodes to produce a set of tokens, an individual token of the set of tokens corresponding to a respective node of the hierarchical set of nodes;
as a result of inputting the set of tokens as input to at least one machine learning model, obtain a set of probabilities for the hierarchical set of nodes, the set of probabilities including subject node probabilities and node of interest probabilities;
identify, based at least in part on the subject node probabilities, a subject node from the hierarchical set of nodes, the subject node being an ancestor of a node of interest;
rank a subset of the set of probabilities that corresponds to descendent nodes of the subject node;
identify, using the node of interest probabilities in the subset of probabilities, the node of interest from the descendent nodes; and
extract data from an object in the interface that corresponds to the node of interest. wherein:

14. The non-transitory computer-readable storage medium of claim 13, wherein:
the node of interest probabilities include, for each node of the set of nodes:
a first set of probabilities of the node corresponding to a first node type; and
a second set of probabilities of the node corresponding to a second node type; and
the executable instructions that cause the computer system to identify the node of interest include instructions that cause the computer system to:
identify the node of interest based at least in part on the first set of probabilities;
identify an additional node of interest based at least in part on the second set of probabilities; and
extract data from an additional object in the interface that corresponds to the additional node of interest.

15. The non-transitory computer-readable storage medium of claim 13, wherein the executable instructions that cause the computer system to identify the subject node include instructions that cause the computer system to:
identify a subject node probability higher than other subject node probabilities of the subject node probabilities; and
identify a node that corresponds to the subject node probability as the subject node.

16. The non-transitory computer-readable storage medium of claim 13, wherein the executable instructions that cause the computer system to identify the node of interest include instructions that cause the computer system to:
identify a node of interest probability higher than other node of interest probabilities in the subset of probabilities; and
identify the node that corresponds to the node of interest probability as the node of interest.

17. The non-transitory computer-readable storage medium of claim 13, wherein the executable instructions further include instructions that further cause the computer system to:
obtain a training set of nodes that represents objects in an example interface;
identify a plurality of nodes of interest within the training set;
determine a lowest common ancestor (LCA) node of the plurality of nodes of interest; and
train, using at least the LCA node as training data, the at least one machine learning model to compute subject node probabilities.

18. The non-transitory computer-readable storage medium of claim 17, wherein the executable instructions further include instructions that further cause the computer system to:
determine classifications of the plurality of nodes of interest; and
train, using the classifications as additional training data, the at least one machine learning model to compute node of interest probabilities.

19. The non-transitory computer-readable storage medium of claim 13, wherein the executable instructions that cause the computer system to identify the subject node further include executable instructions that cause the computer system to:
identify a first subject node candidate with a first subject node probability;
identify a second subject node candidate with a second subject node probability, a difference between the first subject node probability and the second subject node probability being a value relative to a threshold difference; and
determine which of the first subject node candidate or the second subject node candidate is the subject node based at least in part on the node of interest probabilities.

20. The non-transitory computer-readable storage medium of claim 19, wherein the executable instructions that cause the computer system to determine which of the first subject node candidate or the second subject node candidate is the subject node include instructions that cause the computer system to:
combine node of interest probabilities of descendants of the first subject node candidate to produce a first combined probability;
combine node of interest probabilities of descendants of the second subject node candidate to produce a second combined probability; and
determine the subject node based at least in part on the greater of the first combined probability or the second combined probability.
